(19) United States
(12) Patent Application Publication
(10) Pub. No.: US 2015/0284027 A1
(43) Pub. Date: Oct. 8, 2015

(54) Skeleton Semitrailer

(71) Applicants: CIMC VEHICLES GROUP, CO., LTD., Shenzhen, Guangdong (CN); CHINA INTERNATIONAL MARINE CONTAINERS (GROUP) LTD., Shenzhen (CN)

(72) Inventors: Hongrui Wang, Guangdong (CN); Zhengguo Zhang, Guangdong (CN); Lei Shu, Guangdong (CN)

(21) Appl. No.: 14/442,885

(22) PCT Filed: Jun. 18, 2013
(86) PCT No.: PCT/CN2013/077413

§ 371 Date: May 14, 2015

(30) Foreign Application Priority Data
Nov. 16, 2012 (CN) 201210464378.8

(51) Int. Cl. B62D 21/20; B62D 21/12; B62D 21/03

(52) U.S. Cl. CPC B62D 21/20; B62D 21/03; B62D 21/12

(57) ABSTRACT

A combined-type light load crossbeam (2) which is horizontally arranged is arranged in the middle portion of a crossbar (1) of a frame of the skeleton semitrailer, and two combination locksets which are used for fixing two adjacent corner columns of two containers are arranged at two ends of the light load crossbeam (2). The combination lockset comprises a pair of lifting locks (5), turnover locks (6) or fixing locks, or a combination of any two thereof. The two locksets of the combination lockset are separately arranged at the front and back of an end of the light load crossbeam (2), or short beams (3) of the locksets are separately arranged at an outer side of the end of the light load crossbeam (2). Thereby, the number of crossbeams is reduced, the weight of the skeleton semitrailer is lightened, and the structure of the frame is simplified.

### TECHNICAL FIELD

The present invention relates to a technical filed of transportation equipment and a skeleton semitrailer, in particular, to a crossbeam structure of the skeleton semitrailer configured to fix corner columns of a container.

### BACKGROUND

A skeleton semitrailer is a transportation tool facility usually utilized in container transportation; the conventional skeleton semitrailer may transport one container of 40 feet or one container of 20 feet, and also transport two containers of 20 feet.

Currently, skeleton semitrailer existed in market has two locksets mounted at two ends of the crossbeam, respectively. When the skeleton semitrailer loads two containers simultaneously, two separate crossbeams are arranged in the middle portion of a frame, and are distanced closer to each other. If the skeleton semitrailer transports the container, two longitudinal beams on the bottom portion of the entire container are in contact with the two longitudinal beams of the skeleton semitrailer, thereby, the two longitudinal beams of the skeleton semitrailer are the main force-bearing members, the locksets at the two ends of the crossbeam only take a function of positioning, and the force-bearing is relatively smaller.

In the existing art, the skeleton semitrailer has some shortcomings: complex structure with many parts, lower material utilization, heavier weight, not be compact and optimized, and inaesthetic.

### SUMMARY

The technical problem to be solved by the present invention is to provide a skeleton semitrailer with a combined type light load crossbeam, in which two crossbeams in the middle portion of a frame of the skeleton semitrailer are incorporated into one combined type light load crossbeam, and each end of the crossbeam is connected with two locksets for fixing the two adjacent corner columns of the two containers.

A technical solution directed to the above technical problem is to provided a skeleton semitrailer, comprising longitudinal frame beam that is longitudinally arranged, characterized in that a combined type light load crossbeam is horizontally arranged across the middle portion of the longitudinal frame beam; and at each end of the light load crossbeam a combination lockset configured to fix two adjacent corner columns of two containers is arranged.

Wherein, a crossbeam reinforcing rib is arranged between the lower portion of the light load crossbeam and a web plate of the longitudinal frame beam.

Wherein, the combination lockset comprises a pair of lifting locks, turnover locks or fixing locks, or the combination of any two locksets.

Wherein, the two locksets of the combination lockset are arranged at outer side of the ends of the light load crossbeam via lockset short beams.

Furthermore, a short beam reinforcing rib is arranged between the lockset short beam and the light lock crossbeam.

As compared with the existing skeleton semitrailer, the technical solution of the present invention is employed with following advantages:

The two crossbeams are incorporated into one so that number of the crossbeams is reduced and weight of the skeleton semitrailer is lightened.

The structure of the frame is simplified to be simple, reliable, compact and aesthetic.

### BRIEF DESCRIPTION OF THE DRAWINGS

Contents as illustrated by drawings and reference signs therein will be described below.

FIG. 1 is a partial perspective view of the first embodiment of a skeleton semitrailer according to the present invention;

FIG. 2 is an enlarged view of an end of a light load crossbeam in FIG. 1;

FIG. 3 is a perspective view showing working state of a combination lockset according to the first embodiment of the present invention;

FIG. 4 is a perspective view of working state of a combination lockset according to the second embodiment of the present invention.

In the drawings, the reference signs are contained as follows: longitudinal frame beam 1; crossbar web plate 11; light load crossbeam 2; crossbeam reinforcing rib 21; lockset short beam 3; short beam reinforcing rib 31; lifting lock 5; lifting lock core 51; lifting lock seat 52; lifting handle 53; turnover lock 6; turnover lock core 61; turnover lock seat 62.

### DETAILED DESCRIPTION

The embodiments of the present invention will be illustrated in detail in conjunction with the drawings in order to further explain principle and structure of the present invention.

A skeleton semitrailer of the present invention can effectively solve the problems existed in the existing skeleton semitrailer in such manners that two crossbeams distanced closer to each other in the middle portion of the frame of the existing skeleton semitrailer are incorporated into one combined type light load crossbeam, and the two ends of the crossbeam are separately connected with two locksets configured to fix the two adjacent corner columns of the two containers simultaneously.

FIG. 1 is a partial perspective view of the first embodiment of the skeleton semitrailer according to the present invention. As shown in FIG. 1, the first embodiment of the present skeleton semitrailer comprises a longitudinal frame beam 1 longitudinally arranged, in which a combined type light load crossbeam 2 horizontally arranged may be arranged in the middle portion thereof. Two crossbeam reinforcing ribs 21 in parallel are separately arranged between the lower outer side of the light load crossbeam 2 and the outer side of a web plate 11 of the longitudinal frame beam 1. Combination locksets used to fix two adjacent corner columns of two containers may be separately arranged at the two ends of the light load crossbeam 2.

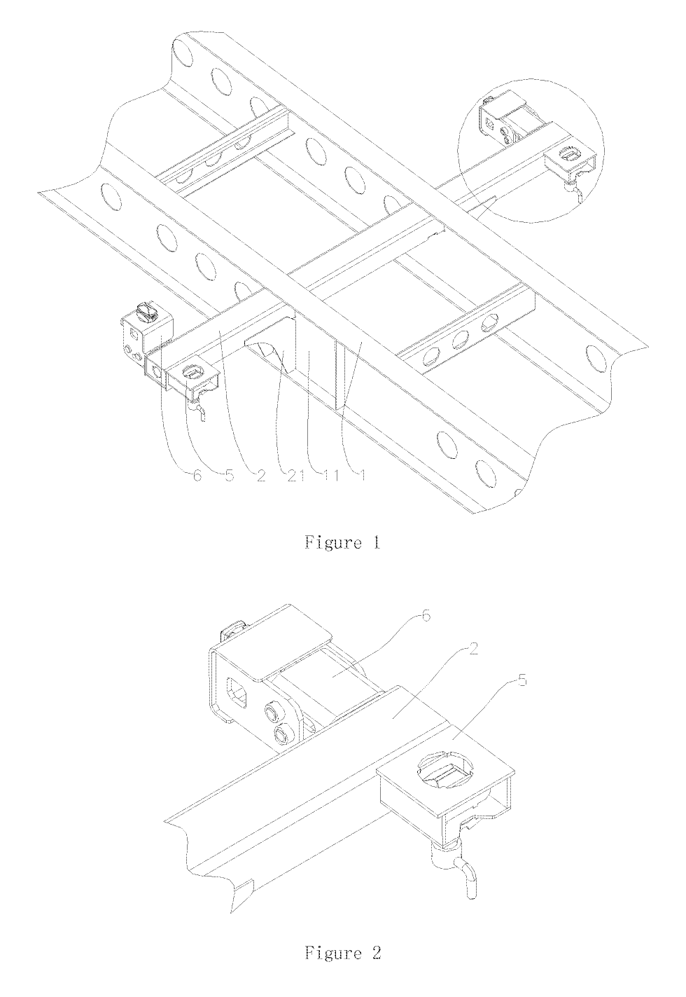

FIG. 2 is a partial enlarged view of the combination lockset arranged at the ends of the light load crossbeam 2 in FIG. 1. As shown in FIG. 2, the combination lockset may be the combination of a lifting lock 5 and a turnover lock 6, both in non-working state. The combination lockset may also employ a pair of lifting locks 5, a pair of turnover locks 6, a pair of fixing locks, or a combination of any two locksets.

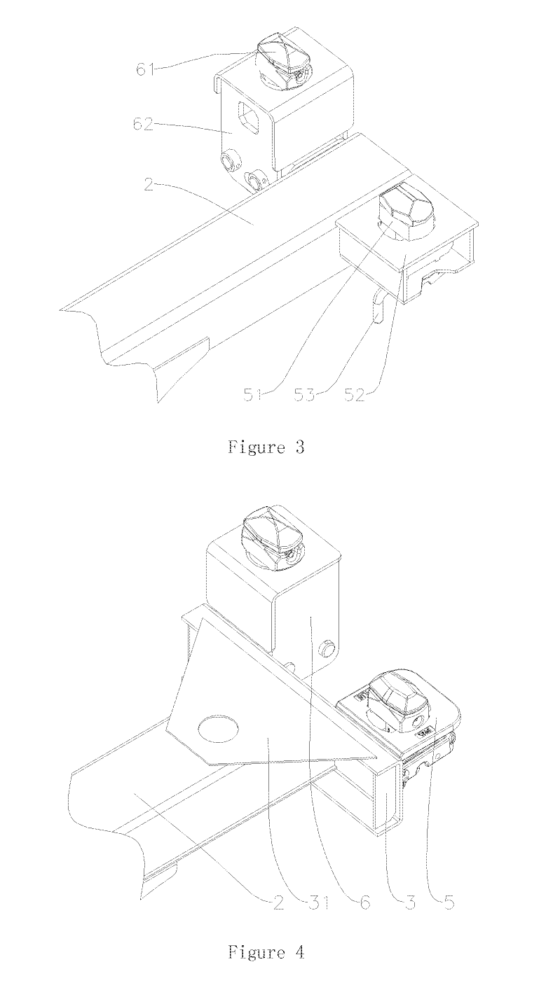

Referring to FIG. 2 and FIG. 3 showing a structure of the combination lockset according to the first embodiment, two locksets are separately arranged at the front and back ends of the light load crossbeam 2. The structure of the combined type light load crossbeam of the skeleton semitrailer according to the present invention may be configured to solve the problems existed in the prior art effectively. The two crossbeams in the middle portion of the frame are incorporated into one light load crossbeam 2, and the ends of the crossbeam are separately connected with two locksets to fix the two adjacent corner columns of the two containers.

Referring to FIG. 4 showing a structure of the combination lockset, of the second embodiment of the skeleton semitrailer according to the present invention, two locksets are arranged at outer side of the end of the light load crossbeam 2 via a lockset short beam 3. A short beam reinforcing rib 31 is arranged between the lockset short beam 3 and the light load crossbeam 2. As shown in FIG. 4, the two locksets may be separately connected with the outer side of the lockset short beam 3, and the inner side of the lockset short beam 3 may be connected with the light load crossbeam 2. The light load crossbeam 2 is also a single beam connected with the middle portion of the longitudinal frame beam 1, and the ends of the crossbeam 2 are separately connected with two locksets. Such structure may be directed to the combined type structure, and also falls within the protection scope of the present invention.

The present invention belongs to a crossbeam structure for a multi-functional skeleton semitrailer, a pair of locksets that are arranged at the front and back may be separately mounted at two ends of such combined type light load crossbeam 2 to fix the two adjacent corner columns of the two container simultaneously. Such design as the combined type single crossbeam may be employed so that the structure of the frame is optimized, number of the crossbeams is reduced, and weight of the skeleton semitrailer is lightened.

The present invention has important features: the crossbeam employs a single combined type light load crossbeam structure; and the two ends of the light load crossbeam 2 are separately connected with the two locksets; and the locksets at the two ends of the load crossbeam 2 may be fixing locks, lifting locks, and turnover locks.

The present invention has a core member, i.e., the light load crossbeam 2, which may be directly welded to the longitudinal frame beam 1. Additionally, a crossbeam reinforcing rib 21 may be welded at the crossbar web plate 11 in order to play a function of reinforcing. The combination locksets, such as the lifting locks 5, the turnover locks 6 and the fixing locks, are separately connected with the ends of the light load crossbeam 2, so that the core structure of the present invention is formed.

In the existing skeleton semitrailer, two locksets at the ends of the two crossbeams in the middle portion of the frame are distanced closer to each other in the working state. By design optimization and locally reinforcement, on base that rigid and strength has been met, two crossbeams in the middle portion of the longitudinal frame beam are incorporated into one combined type light load crossbeam, and the two locksets may be combined and then connected to the end of the light load crossbeam 2.

FIG. 2 and FIG. 3 show a process of the combined lock being converted into the working state from the non-working state. A lifting lock core 51 of the lifting lock 5 moves upwardly to be fixed to a lifting lock seat 52. After the container falls in a proper place, a lifting handle 53 may be rotated for a determined angle to fix corner fittings of one container. A turnover lock 6 may be rotated upwardly by a determined angle to permit a turnover lock core 61 to be in a perpendicular state, and then fix a turnover lock seat 62. When the container falls in a proper place, the turnover handle may be rotated by a determined angle to fix the corner fittings of the other container.

It should be noted that the lifting lock 5 and the turnover lock 6 may not be connected with the light load crossbeam 5 by the way of welding but by means of bolts and other means. The combination lockset may not be the turnover lock 6, but the lifting lock 5 and the other fixing lock. Any technical solution that one combined type light load crossbeam 2 may be employed, and the ends of the light load crossbeam 2 may be separately connected with two locksets, falls within extent for protection therein.

According to the above analysis, it should be noted that turnover direction of the turnover lock 6 may be a front and back direction, and also a left and right direction. In addition, the two locksets at the ends of the crossbeam (as above shown) have different height, so that height difference is required if the skeleton semitrailer are mounted on a gooseneck semitrailer; and the horizontal height of the two locksets are in consistent if the skeleton semitrailer are mounted on a straight beam semitrailer. Their essential structure is the combined type light load crossbeam structure, within the protection scope of the present invention.

The skeleton semitrailer with a structure of the combined type light load crossbeam of according to the present invention may be capable to solve the problems existed in the prior art effectively in such manner that the two cross beams in the middle portion of the frame are incorporated into one combined type light load crossbeam, and the two ends of the crossbeam are separately connected with two locksets configured to fix the two adjacent corner columns of the two containers. Thereby, the structure is simple, the number of the parts is reduced, and the weight thereof is lightened, besides that it is compact and aesthetic.

The embodiments of the present invention have been illustrated as described above but not limited to the disclosed embodiments. Those skilled in the art could make corresponding variations or modifications in accordance with concept and spirit of the present invention, so that extent for protection of the present invention should be determined by that of the claims.

What is claimed is:

1. A skeleton semitrailer, comprising a longitudinal frame beam, characterized in that a combined type light load crossbeam is horizontally arranged across the middle portion of the longitudinal frame beam; and at each end of the light load crossbeam a combination lockset configured to fix two adjacent corner columns of two containers is arranged.

2. The skeleton semitrailer according to claim 1, characterized in that a crossbeam reinforcing rib is arranged between the lower portion of the light load crossbeam and a web plate of the longitudinal frame beam.

3. The skeleton semitrailer according to claim 2, characterized in that the combination lockset comprises a pair of lifting locks, a pair of turnover locks, and a pair of fixing locks, or the combination of any two locksets.

4. The skeleton semitrailer according to claim 3, characterized in that two locksets of the combination lockset are separately arranged at the front and back of each end of the light load crossbeam.

5. The skeleton semitrailer according to claim 3, characterized in that the two locksets of the combination lockset are arranged at outer side of the ends of the light load crossbeam via lockset short beams.

6. The skeleton semitrailer according to claim 5, characterized in that a short beam reinforcing rib is arranged between the lockset short beam and the light load crossbeam.
